(19) United States
(12) Patent Application Publication
(10) Pub. No.: US 2003/0019701 A1
(43) Pub. Date: Jan. 30, 2003

(54) Bladder for use in a damping device

(75) Inventor: Scott Hodgson, Hesperia, CA (US)

Correspondence Address: WORKMAN NYDEGGER & SEELEY, 1000 EAGLE GATE TOWER, 60 EAST SOUTH TEMPLE, SALT LAKE CITY, UT, 84111, US

(73) Assignee: Progressive Suspension, Inc.,

(21) Appl. No.: 10/125,279

(22) Filed: Apr. 17, 2002

Related U.S. Application Data
(60) Provisional application No. 60/285,446, filed on Apr. 19, 2001.

(51) Int. Cl. F16F 9/34; F16F 9/08

(52) U.S. Cl. 188/298; 188/322.13

(57) ABSTRACT

In an embodiment, the present invention provides a damping device that comprises a bladder that has an exterior surface and an interior surface, with the interior surface defining a chamber which stores a compressible fluid and a valve that is attached to the interior surface of the bladder. In an embodiment, the damping device contains a bladder that can be constructed from one or more of the following materials: urethane, neoprene, Viton, Nitrile, buna rubber, or silicon. The bladder is constructed to minimize the distance between the interior surface and the exterior surface. In an embodiment, the damping device contains a valve that can be constructed from one of the following materials: steel, brass, aluminum, or composite. The valve includes a stem that has threads for attaching a nut and a flange for attaching the valve to the interior surface of the bladder. The flange is contoured to maintain the axial location of the bladder within the damping device. In an embodiment, the flange is constructed from a material that is attachable to the interior surface of the bladder. In operation, compressible fluid is introduced into the bladder through the valve, with the valve permitting the adjustment of the internal pressure of a fluid contained within the bladder. The fluid volume within the bladder in an expanded condition as compared to the total displaceable volume of the piston rod is in a ratio of about 3:1. In an embodiment, the pressure within the bladder is at least 100 p.s.i, or at least 150 p.s.i.

This application claims the benefit of U.S. Application Ser. No. 60/285,446 filed on Apr. 19, 2001, which is hereby fully incorporated by reference herein as though set forth in full.

### BACKGROUND OF THE INVENTION

1. Field of the Invention

The present invention relates generally to bladders for use in damping devices.

2. Description of Related Art

The following description includes information that may be useful in understanding the present invention. It is not an admission that any of the information provided herein is prior art, or relevant, to the presently claimed inventions, or that any publication specifically or implicitly referenced is prior art.

A damping device is used to control the motions that are imparted to a vehicle as it is subjected to imperfections in the surface that the vehicle is traveling over. One type of damping device that is commonly used in vehicles is a shock absorber. There are two principal kinds of shock absorbers that are used in bicycles and motor vehicles, twin tube shock absorbers and monotube shock absorbers. Bicycle and motor vehicle manufacturer have generally favored the use of twin tube shock absorbers over monotube shock absorbers due to their lower cost. However, as currently assembled, twin tube shock absorbers generally are not able to provide some of the high performance damping characteristics that are associated with monotube shock absorbers. This has limited the use of twin tube shock absorbers to vehicles where performance handling is not considered to be important.

A common problem encountered with the use of shock absorbers is the separation of the hydraulic fluid, which is generally oil, from a compressible fluid, which is commonly a gas, such as air or nitrogen. In shock absorbers where the hydraulic fluid comes into direct contact with a gas, the hydraulic fluid and the gas can mix as the shock absorber is compressed in response to the motor vehicle going over an imperfection in the roadway. This mixing can lead to the entrapment of air bubbles in the hydraulic fluid, and the concomitant formation of foam as the shock absorber rebounds to an expanded condition. Failure of the gas to rapidly separate from the hydraulic fluid can reduce the ability of a shock absorber to compress and rebound effectively, particularly if the shock absorber is forced to compress and rebound rapidly or repetitively, for instance, due to a series of closely spaced imperfections in the roadway. To overcome this deficiency, present shock absorber designs have incorporated a separation device that is capable of forming an impermeable barrier between the hydraulic fluid and the gas.

Two commonly utilized separation devices are a freon cell and a closed cell foam. These separation devices are filled with air at a low pressure and sealed closed prior to insertion into the shock absorber. These separation devices are typically utilized by vehicles where performance handling is not required. Finally, these separation devices are prone to failure during general use of the shock absorber within which they are installed. The present invention provides a separation device that in one embodiment can store a fluid under high pressure and provides a valve through which a fluid can be administered after the separation device is inserted into the damping device. The valve of the present invention allows for the insertion or removal of fluid from the separation device following insertion into the damping device.

### SUMMARY

In an embodiment, the present invention provides a damping device that comprises a bladder that has an exterior surface and an interior surface, with the interior surface defining a chamber which stores a compressible fluid and a valve that is attached to the interior surface of the bladder. In an embodiment, the damping device contains a bladder that can be constructed from one or more of the following materials: urethane, neoprene, Viton, Nitrile, buna rubber, or silicon. The bladder is constructed to minimize the distance between the interior surface and the exterior surface. In an embodiment, the damping device contains a valve that can be constructed from one of the following materials: steel, brass, aluminum, or composite. The valve includes a stem that has threads for attaching a nut and a flange for attaching the valve to the interior surface of the bladder. The flange is contoured to maintain the axial location of the bladder within the damping device. In an embodiment, the flange is constructed from a material that is attachable to the interior surface of the bladder. In operation, compressible fluid is introduced into the bladder through the valve, with the valve permitting the adjustment of the internal pressure of a fluid contained within the bladder. The fluid volume within the bladder in an expanded condition as compared to the total displaceable volume of the piston rod is in a ratio of about 3:1. In an embodiment, the pressure within the bladder is at least 100 p.s.i., or at least 150 p.s.i.

It is a further object of the present invention to provide a damping device that comprises a first housing that defines a first cavity to contain hydraulic fluid, a piston assembly that is slidably received by the first cavity, a rod joined to the piston assembly for movement therewith, the rod having a first end extending from the housing and a second end movable with the piston assembly during compression and rebound. The damping device further comprises a second housing that defines a second cavity, the second cavity including a bladder of compressible material, the bladder comprising an interior surface and an exterior surface, a valve that is attached to the interior surface of the bladder, the bladder positioned within the second cavity to leave an opening for the flow of hydraulic fluid. The damping device also comprises a connection between the first and the second housing, a passage between the first and the second cavity, and hydraulic fluid passing through the passage during compression and rebound. The damping device is a twin tube shock absorber or a monotube shock absorber. The bladder comprises one or more of the following materials: urethane, neoprene, Viton, Nitrile, buna rubber, or silicon. The bladder is constructed to minimize the distance between the interior surface and the exterior surface. The valve comprises one or more of the following materials: steel, brass, aluminum, or composite. The valve includes a stem having threads for attaching a nut. The valve also includes a flange that attaches the valve to the interior surface of the bladder. The flange is contoured to maintain the axial location of said bladder within the damping device. The flange comprises a material that is attachable to the interior surface of said bladder. The compressible fluid is introduced into said bladder by said valve. The fluid volume within the bladder in an expanded condition as compared to the total displaceable volume of the piston rod, is in a ratio of about 3:1, with the preferred pressure within the bladder being at least 100 p.s.i., or at least 150 p.s.i.

It is an additional object of the present invention to provide a vehicle, comprising a chassis and a damping device coupled to the chassis, the damping device comprising, a first housing that defines a first cavity containing hydraulic fluid, a piston assembly, slidably received by the first cavity, a rod joined to the piston assembly for movement therewith, the rod having a first end extending from the housing and a second end movable with the piston assembly during compression and rebound, a second housing defines a second cavity, the second cavity containing a bladder of compressible material, the bladder comprising an interior surface and an exterior surface, a valve attached to the interior surface of the bladder, the bladder positioned within the second cavity to leave an opening for the flow of hydraulic fluid, a connection between the first and the second housing, a passage between the first and the second cavity, hydraulic fluid passing through the passage during compression and rebound. The vehicle is an airplane, an automobile, a truck, a bicycle, a scale model, an ATV or a motorcycle. The damping device is a twin tube shock absorber, or a monotube shock absorber. The bladder comprises one or more of the following materials: urethane, neoprene, Viton, Nitrile, buna rubber, or silicon. The bladder is constructed to minimize the distance between the interior surface and the exterior surface. The valve is constructed of one of the following materials: steel, brass, aluminum, or composite. The valve contains a stem having threads for attaching a nut and can be fixably attached to the second housing by a nut. The valve also contains a flange that attaches the valve to the interior surface of the bladder. The flange is contoured to maintain the axial location of said bladder within the damping device and comprises a material that is attachable to the interior surface of the bladder. The compressible fluid is introduced into said bladder by said valve. The pressure within the bladder in a compressed condition as compared to an expanded condition is in a ratio of about 3:1, with the preferred pressure within the bladder at least 100 p.s.i., or at least 150 p.s.i.

### BRIEF DESCRIPTION OF THE DRAWINGS

An illustrative and presently preferred embodiment of the preferred embodiment will now be described in detail in conjunction with the drawings of which:

FIG. 1 is a longitudinal cross-sectional view of a piston rod in an extended condition in an embodiment of a twin tube shock absorber in accordance with the present invention.

FIG. 2 is a longitudinal cross-sectional view of a piston rod in a compressed condition in an embodiment of a twin tube shock absorber in accordance with the present invention.

FIG. 3 is a cross-sectional view illustrating the position of a bladder and a valve located with the bladder in an embodiment of a twin tube shock absorber in accordance with the present invention.

FIG. 4 is a cross-sectional view illustrating the placement of a flange and flange seal reinforcement within a bladder in an embodiment of the present invention.

FIG. 5 is an illustration of a bladder in an embodiment of the present invention.

FIG. 6 is a cross-sectional view of a valve and a flange having a curved shape in an embodiment of the present invention.

FIG. 7 is a cross-sectional view of a valve and a flange shown in FIG. 6 in an embodiment of the present invention with the valve rotated 90°.

FIG. 8(a) is a cross-sectional view of a valve secured to an interior surface of a bladder by a flange of a twin tube shock absorber in an embodiment of the present invention.

FIG. 8(b) is a cross-sectional view of a twin tube shock absorber showing a valve secured to an exterior surface of a bladder and the increased thickness of a flange seal reinforcement in an embodiment of the present invention.

FIG. 9 is a longitudinal, cross-sectional view illustrating a piston rod in a compressed condition of a monotube tube shock absorber in an embodiment of the present invention.

### DETAILED DEESCRIPTION OF THE ILLUSTRATED EMBODIMENTS

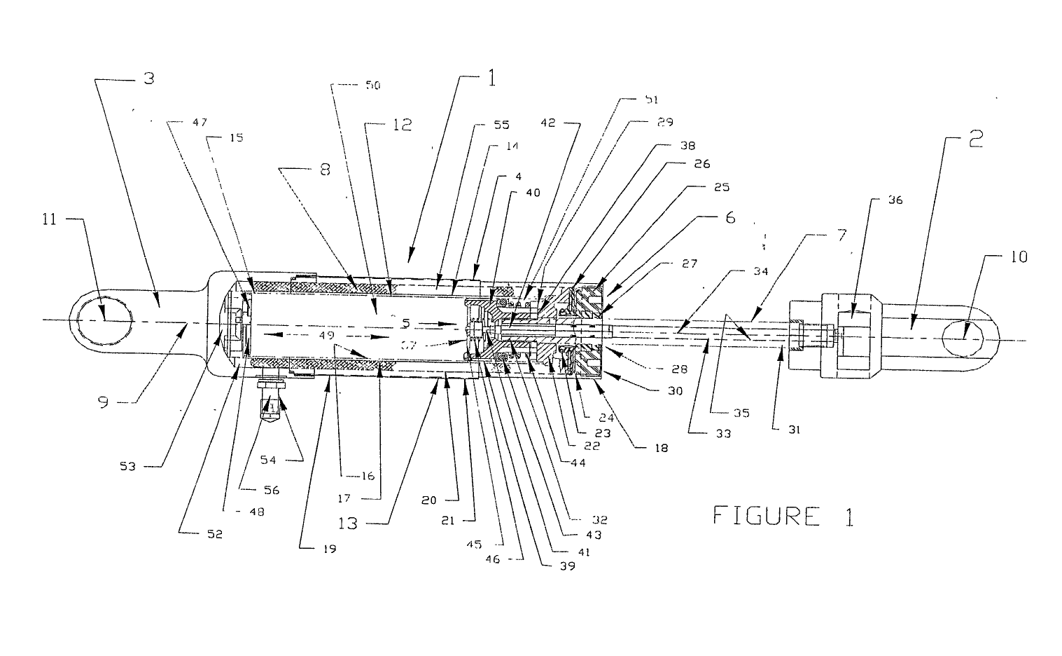

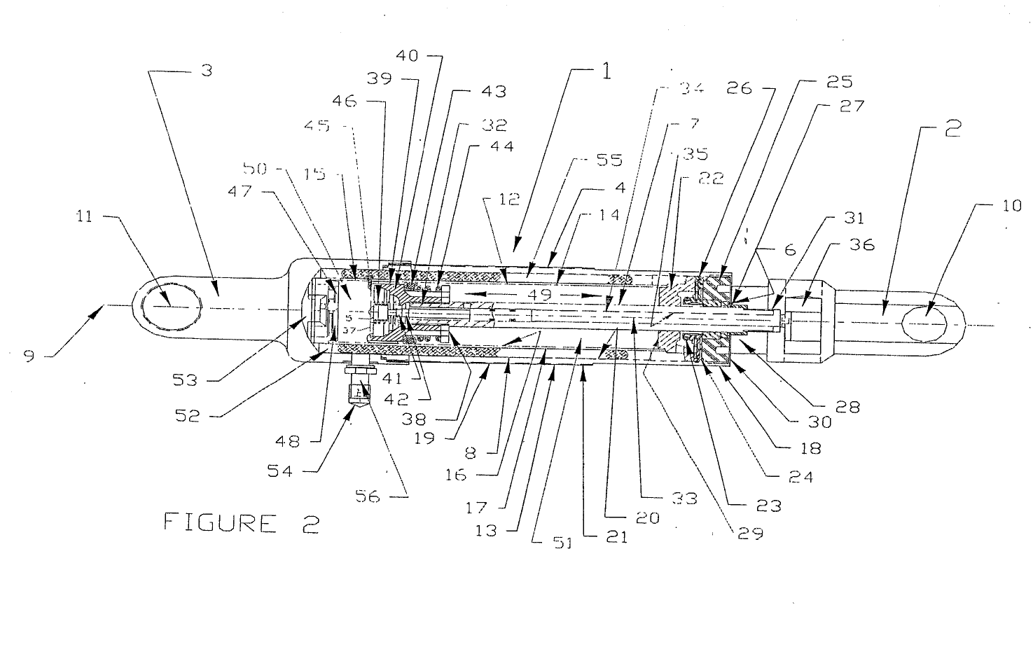

FIG. 1 and FIG. 2 illustrate an embodiment of a damping device in accordance with the present invention. In an embodiment,the damping device is a twin tube shock absorber 1, and comprises rod end mounts 2 and 3, a housing assembly 4, a piston assembly 5 and end cap assembly 6, a piston rod 7 and a bladder 8, located within the housing assembly 4. The piston assembly 5 is mounted within the housing assembly 4 for movement along the longitudinal axis 9. The piston assembly 5 is shown in FIG. 1 in an extended position and a retracted position in FIG. 2.

In an embodiment, rod end mount 2 and body end mount 3 are located on opposite ends of the shock absorber 1. Rod end mount 2 comprises an opening 10, within which is mounted a bushing, which is not shown in FIG. 1, that is comprised of durable, compressible material. The body end mount 3 is also comprised of an opening 11, within which is mounted a bushing comprised of a durable, compressible material.

In an embodiment, the housing assembly 4 comprises an inner housing 12 and an outer housing 13. The inner housing 12 is cylindrical in form, and is defined by two opposite end portions 14 and 15, and an interior wall 16 and an exterior wall 17. The outer housing 13 is also cylindrical in form, and is defined by two opposite ends 18 and 19, and an interior wall 20 and an exterior wall 21. The inner housing 12 and the outer housing 13 are concentrically arranged and positioned relative to one another, so that the respective housing end portions 14 and 15, and 18 and 19 generally correspond to one another. In the alternative, the inner housing 12 and outer housing 13 takes on a shape other than cylindrical. For example, the inner housing 12 and the outer housing 13 can be elliptical or oval in shape. The inner housing 12 and the outer housing 13 are joined at one end by the body end mount 3 and at the opposite end by the end cap assembly 6.

The end cap assembly 6 comprises a rod guide 22, a piston rod seal 23, a closing washer 24, a closing nut 25, an O-ring 26 and a rod wiper seal 27. The end cap assembly 6 further comprises a bore 28 that extends through the end cap assembly 6 from the inner face 29 of the end cap assembly 6 to the outer face 30 of the end cap assembly. As illustrated, the end cap assembly 6 is secured into place within the shock absorber 1 by closing nut 25. When the closing nut 25 is secured into place, the closing nut 25 exerts pressure on the closing washer 24. The pressure exerted by the closing nut 25 on the closing washer 24 results in pressure being exerted by the closing washer 24 on the O-ring 26. This pressure causes the O-ring 26 to form an air-tight seal between the end cap assembly 6 and the outer housing 13.

The shock absorber 1 further comprises a piston rod 7 that is in the form of an elongated shaft. The piston rod 7 has two opposite end portions 31 and 32, wherein end portion 31 is secured within the rod end mount 2 and end portion 32 is secured to the piston assembly 5. The piston rod 7 extends through the bore 28 within the end cap assembly 6 into the housing assembly 4. The piston rod 7 is of such size and shape to be closely, yet slidably received, by the bore 28 within the end cap assembly 6. The receipt of the piston rod 7 by the bore 28 within the end cap assembly 6 permits the piston rod 7 to be slidably moved relative to the housing assembly 4 between an extended position as shown in FIG. 1 and a retracted position as shown in FIG. 2. In one embodiment, the piston rod 7 has a channel 33 to receive an adjustment rod 34. The diameter of the channel 33 is of such size to allow the close receipt of the adjustment rod 34 and to allow the sliding movement of the adjustment rod 34 relative to, and lengthwise along the interior wall 35 of the channel 33. The adjustment rod 34 is moved by an adjustment cam 36 that is in contact with the adjustment rod 34, such that movement of the adjustment cam 36 results in movement of the adjustment rod 34 through the channel 33 within the piston rod 7.

The piston assembly 5 has an inner face 37 and an outer face 38. In an embodiment, the piston rod 7 is cylindrical in shape. In an alternative embodiment, the piston assembly 5 is elliptical or oval in shape. The piston assembly 5 has an outer surface 39, whose diameter is of such size to be closely received by, yet permit sliding movement of, the piston assembly 5 relative to and lengthwise along the interior wall 16 of the inner housing 12. The piston assembly 5 comprises a piston ring connected to the piston 40, which is attached to the piston rod 7. The piston 40 has at least one opening 41 that extends through the piston 40 from the inner face 37 of the piston assembly 5 to the outer face 38 of the piston assembly. Depending upon the embodiment, the size of the opening 41 can be varied depending on the location of the rebound pin 42. In an embodiment, the rebound pin 42 is tapered in shape and is located at a fixed location within the opening 41, so that the opening 41 is of a fixed, determinable size. In an alternative embodiment, the rebound pin 42 is not located at a fixed position. Instead, the location of the rebound pin 42 can be adjusted by moving the rebound pin 42 into, or out of, the opening 41. The rebound pin 42 is moved into, or out of, the opening 41 by the adjustment rod 34. By moving the rebound pin 42, the size of the opening 41 can be increased or decreased. The piston can also contain additional openings (not shown) that surround the opening 41. In an embodiment, these additional openings are fixed in size. In an embodiment, the piston assembly 5 further comprises a combination 43, that consists of a protector and an O-ring that sit on the outside of the piston 40 and a compression blow off spring 44. The piston assembly 5 also comprises a recoil valve retainer 45 and recoil valve blow off spring 46 that are located on the inner face of the piston assembly 5.

The inner surface 16 of the inner housing 12, in conjunction with the end cap assembly 6 at end portion 14 and the compression valve 47 and replenishing valve 48 at end portion 15, respectively, collectively define an elongated cavity 49 having a longitudinal axis 9. As seen in FIG. 2, the piston assembly 5 divides the elongated cavity 49 into first and second variable volume cavities 50 and 51. The first variable volume cavity 50 is defined by the inner surface 16 of the inner housing 12, end portion 15 and the inner face 37 of the piston assembly 5. The second variable volume cavity 51 is defined by the inner surface 16 of the inner housing 12, end portion 14 and the outer face 38 of the piston assembly 5. As the piston assembly 5 moves along the length of, and relative to, the longitudinal axis 9 of the elongated cavity 49 in an axial direction between ends 14 and 15, the internal volume of the first chamber 50 increases or decreases while the internal volume of the second chamber 51 decreases or increases respectively.

In an embodiment, the space between the exterior surface 17 of the inner housing 12 and the inner surface 20 of the outer housing 13 provides for an annular cavity 52 that encircles the elongated cavity 49. Flow communication between the elongated cavity 49 and the annular cavity 52 is provided by a passageway 53 that extends from the first variable volume cavity 50 of the elongated cavity 49 through the compression valve 47 to the annular cavity 52 and from the annular cavity 52 through the replenishing valve 48 back to the first variable volume cavity 50 of the elongated cavity 49. In the shock absorber illustrated in FIG. 1 and FIG. 2, a bladder 8 containing a valve 54 is positioned within the annular cavity 52.

To prepare the shock absorber 1 for use, the elongated cavity 49 and the annular cavity 52 are filled with a hydraulic fluid. In one embodiment, the hydraulic fluid is oil. In addition, the bladder 8 is pressurized with a fluid through the valve 54 to a predetermined internal pressure. In one embodiment, the fluid that is used to pressurize the bladder 8 is a gas, such as air or nitrogen. The force required to compress the shock absorber 1 can be increased or decreased by adjusting the internal fluid pressure within the bladder 8. The internal fluid pressure can be adjusted by introducing fluid into the interior chamber 55 through the valve 54, or by removing the fluid from the interior chamber 55. When the internal fluid pressure is increased within the bladder 8, the bladder 8 is more resistant to compression. By maintaining either a low internal fluid pressure or no internal fluid pressure within the bladder 8, the bladder is less resistant to compression.

As illustrated in FIGS. 1 and 2, the bladder 8 encircles and effectively covers a major portion of the inner surface 20 of the outer housing 13 and the outer surface 17 of the inner housing 12. The fluid flow path extends along the longitudinal axis of the annular cavity 52 and defines the remaining portion of the annular cavity 52 that is not encompassed by the bladder 8.

The shock absorber 1 illustrated in FIG. 1 and FIG. 2 can be mounted between a vehicle frame or chassis and a wheel assembly. Among the vehicles that the shock absorber can be attached to are the frame and wheel assembly of a motorcycle or bicycle, or the chassis and wheel assembly of a scale model, automobile, truck, or tractor, or airplane. Depending upon the embodiment, the shock absorber illustrated in FIG. 1 and FIG. 2 can be mounted with the rod end mount 2 mounted in an upward position, secured to the frame or chassis with the body end mount 3 secured in a downward position, to the wheel assembly, or the rod end mount 2 can be secured in a downward position, to the wheel assembly, with the body end mount secured in an upward position to the frame or chassis. Moreover, depending upon the embodiment, the shock absorber illustrated in FIG. 1 and FIG. 2 can be secured with the shock absorber in a straight up and down position, or with the shock absorber 1 angled towards, or away from, the vehicle to which the shock absorber 1 is mounted.

Illustrated in FIG. 1, the shock absorber 1 comprises the piston rod 7 in an extended position relative to the housing assembly 4. As force is applied, and the shock absorber 1, illustrated in FIG. 1, is compressed, the piston assembly slidably moves through the elongated cavity 49 and the piston rod moves from the extended position to the retracted position that is illustrated in FIG. 2. The piston rod 7 is guided during compression, as the piston rod 7 enters the elongated cavity 49, by the rod guide 22. The rod guide 22 also functions to form a mechanical seal to close off the top end of the annular cavity 52. To prevent debris, such as dirt or dust, from entering the elongated chamber during compression, the piston rod 7 slidably moves through the rod wiper seal 27.

As the piston assembly 5 slidably moves through the elongated cavity 49, some of the hydraulic fluid located in the first variable volume cavity 50 flows through the openings located within the piston assembly 5 from the first variable volume cavity 50 into the second variable volume cavity 51. The hydraulic fluid is prevented from flowing in the space located between the piston assembly 5 and the interior surface 16 of the inner housing 12 by the piston ring. The piston ring is bound to the piston assembly 5 and forms an impermeable barrier that extends between the piston assembly 5 and the interior surface 16 of the inner housing 12. The amount of hydraulic fluid that can flow through the piston assembly 5 can be controlled by the size of the openings in the piston assembly 5 through which the hydraulic fluid flows. Depending upon the embodiment, the amount of hydraulic fluid that can flow through the opening 41 located in the middle of the piston assembly 5 can be varied by adjusting the opening 41 by changing the location of the rebound pin 42 within the opening 41. The rebound pin 42 can be moved into, or out of, the opening 41 by the adjustment rod 34, which slidably moves through the channel 33 within piston rod 7. The position of the adjustment rod 34 is determined by the adjustment cam 36 that is in close contact with the adjustment rod 34, such that movement of the adjustment cam 36 results in movement of the adjustment rod 34 through the channel 33 within the piston rod 7. The amount of hydraulic fluid that can flow through the piston assembly 5 can also be controlled by changing the size of the openings that surround the opening 41 in the piston assembly 5. These openings are generally fixed in size and the size of the opening is generally not adjustable. By making these openings larger, the flow of hydraulic fluid from the first variable volume cavity 50 to the second variable volume cavity 51 can be increased, while making the openings smaller will decrease the flow of hydraulic fluid from the first variable volume cavity 50 to the second variable volume cavity 51.

Additional hydraulic fluid located in the first variable volume cavity 50 is forced by the piston assembly 5 and piston rod 7 into the annular cavity 52, through the compression valve 47, that has variable openings and into the interior passage 53, located between the compression valve 47 and the annular cavity 52. As hydraulic fluid moves through the interior passage 53 and into the annular cavity 52, pressure is exerted by the hydraulic fluid on the bladder 8. As the pressure increases during the compression phase, the bladder 8 begins to compress. The force required to compress the bladder can be dependent on the internal fluid pressure of the bladder 8. When the bladder 8 contains fluid under high pressure, the bladder can be more difficult to compress than when the fluid is stored within the bladder 8 under either low internal pressure or no internal pressure. Generally, where a shock absorber 1 contains a bladder 8 containing fluid stored under high internal pressure, more force is required to slidably move the piston assembly 5 and the piston rod 7 through the elongated chamber 49, from the position illustrated in FIG. 1 to the position illustrated in FIG. 2, than if the fluid contained in the bladder 8 was stored under either low internal pressure or no internal pressure. A shock absorber 1 containing a bladder 8 with fluid stored under high internal pressure is generally considered a high performance shock absorber.

As the bladder 8 compresses, the bladder 8 acts as an accumulator, storing the energy that is created by the pressure exerted by the hydraulic fluid on the bladder 8. In an embodiment, the ratio of the pressure between the compressed and initial condition is 3:1. As the compression phase ends and the shock absorber begins to rebound, illustrated in going from the position of the piston assembly 5 and piston rod 7 in FIG. 2 to the location of the piston assembly 5 and piston rod 7 in FIG. 1, the energy stored within the bladder 8 begins to be released. As the bladder 8 begins to expand, hydraulic fluid that had moved into the annular cavity 52 during compression, is forced to move back through the interior passage 53 through the replenishing valve 48 and back into the elongated cavity 49. As the hydraulic fluid moves back into the elongated cavity 49, the piston assembly 5 and the piston rod 7 slidably move through the elongated cavity 49 towards the end cap assembly 6. At the end of the rebound phase, the bladder 8 is fully expanded and the piston rod 7 has fully extended out of the housing assembly 4, with the shock absorber 1 returning to the position illustrated in FIG. 1.

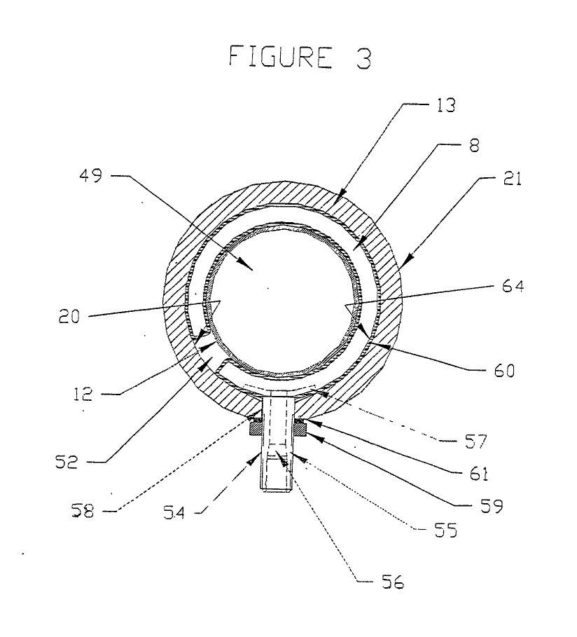

As illustrated in FIG. 3, the bladder 8 is secured to a valve 54 that is comprised of a valve stem 56 and a flange 57. The valve 54 is secured to the interior surface 57 of the bladder 8 by the flange 57. The bladder 8 is secured to the outer housing 13 by the valve 54, which is received by the opening 58 in the outer housing 13 and operatively secured to the outer housing 13 by a nut 59. Once the bladder 8 is secured to the outer housing, a fluid tight seal is formed that prevents hydraulic fluid from inside the annular cavity 52, or fluid stored inside the bladder 8, from escaping or leaking through the opening 58 to the outer surface 21 of the outer housing 13.

As further illustrated in FIG. 3, the axial location of the bladder 8 can be fixed into place within the shock absorber by the flange 57 when the valve 54 is fixably attached to the outer housing 13 by the nut 59, thus securing the bladder 8 to the inner surface 20 of the outer housing 13. In an embodiment, the flange 57 is curved and coincides with the shape of the inner surface 20 of the outer housing 13. By having the flange 57 coincide in shape with the inner surface 20 of the outer housing 13, the flange 57 is prevented from rotating or moving in any direction once the bladder 8 has been secured to the inner surface 20 of the outer housing 13. Since the flange 57 is not able to rotate or move, the bladder 8 is also prevented from moving within the annular cavity 52. Therefore, the bladder 8 is not subjected to motions that can cause abrasions on the exterior surface 60 of the bladder 8 and can result in the rupturing of the bladder 8. Rupturing of the bladder 8 would result in the release of the fluid stored in the bladder 8 into the annular cavity 52 and cause the shock absorber to not function properly. The inability of the bladder 8 to move within the annular cavity 52 also ensures the integrity of the hydraulic fluid flow path within the annular cavity 52, since the bladder 8 cannot alter its axial configuration to block off the fluid flow path.

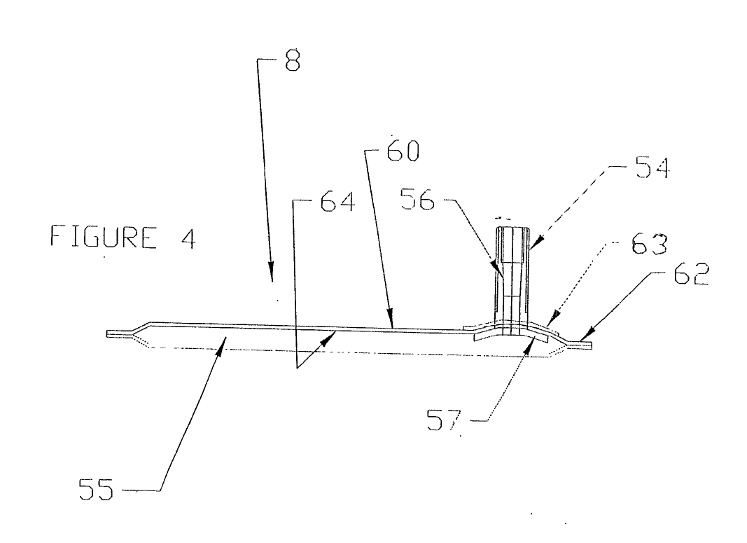

An embodiment of the bladder 8 is further illustrated in FIG. 4 and FIG. 5. The bladder 8 comprises an exterior surface 60 and an interior surface 64. In an embodiment, the interior surface 64 faces into and defines an interior chamber 55 for the storage of a compressible fluid under pressure. The bladder further comprises a perimeter seal 62 that defines the edges of the bladder 8. The bladder 8 also comprises a flange seal reinforcement 63, that surrounds the valve 54 and is secured to the exterior surface 60 of the bladder 8. The flange seal reinforcement 63 and the flange 57, when secured to the bladder 8, form an air-tight seal at the opening in the bladder 8 through which the valve 54 is received. In an embodiment, the bladder 8 is constructed from a material that is compressible, resilient and capable of forming an impermeable barrier withstanding high temperatures and the outward pressure that is exerted by the fluid located within the bladder 8. In an embodiment, the materials used to construct the bladder 8 can include, but are not limited to: urethane, neoprene, Viton, Nitrile, buna rubber, or silicon. The valve 54 attached to the bladder 8 permits pressurization of the bladder 8 to the desired internal pressure. The valve 54 comprises a valve stem 56 and a flange 57. The valve 54 is secured to the interior surface 64 of the bladder 8 by the flange 57. In the embodiment illustrated in FIG. 4 and FIG. 5, the valve 54 has been attached to one corner of the bladder 8. In alternative embodiments, the valve can be attached to the bladder 8 in the center of the bladder 8, the corners of the bladder 8, or along the edges of the bladder 8.

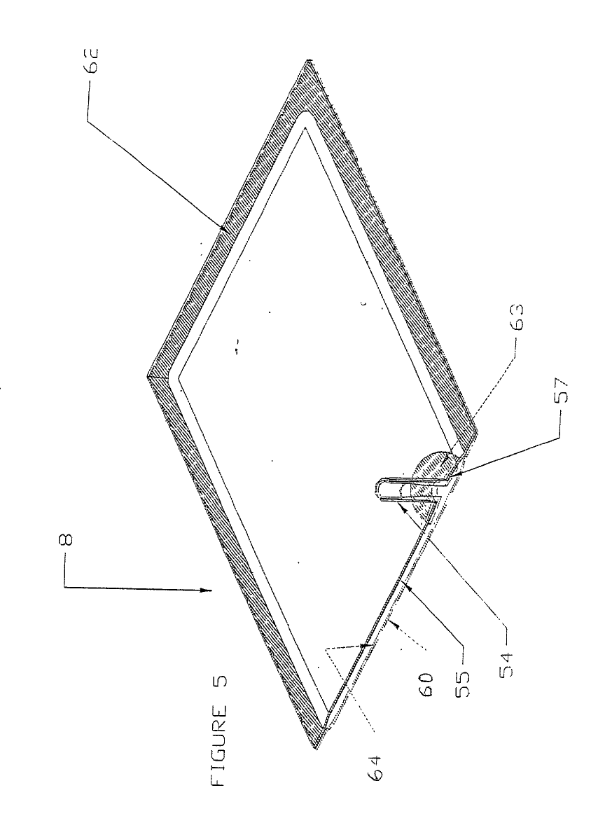

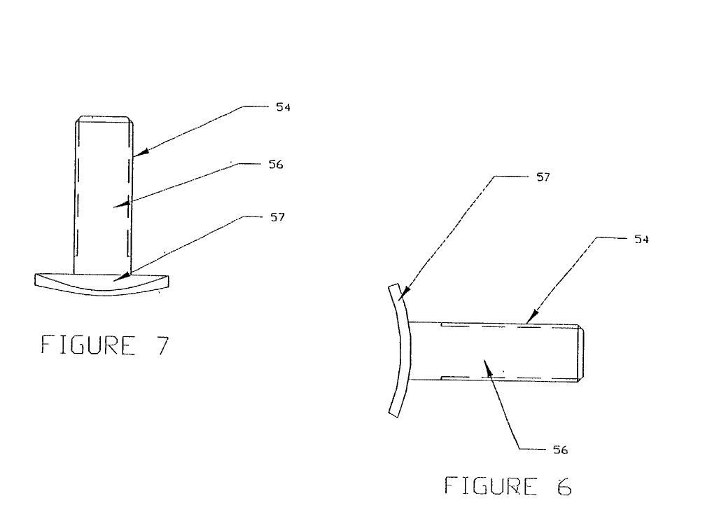

In an embodiment, the valve 54, as illustrated in FIG. 6 and FIG. 7, is a pressure valve comprising the valve stem 56, the flange 57 and a valve core located within the valve stem 56. In one embodiment, the valve 54 is a standard Schraeder automotive valve or a Presta valve. In an embodiment, the valve 54 is formed from a single piece of material, so that the valve stem 56 and the flange 57 comprise a single, contiguous unit. In an embodiment, materials from which the valve 54 can be constructed, include, but are not limited to: steel, brass, aluminum, rubber, or a composite material. Among the composite materials that can be used are nylon, plastic, or carbon fiber. In one example, the valve 54 is created from a single piece of 12L14 metal. In another embodiment, the valve is constructed of a material that allows the flange 57 to be secured to the interior surface 64 of the bladder 8, as illustrated in FIGS. 3, 4, and 5.

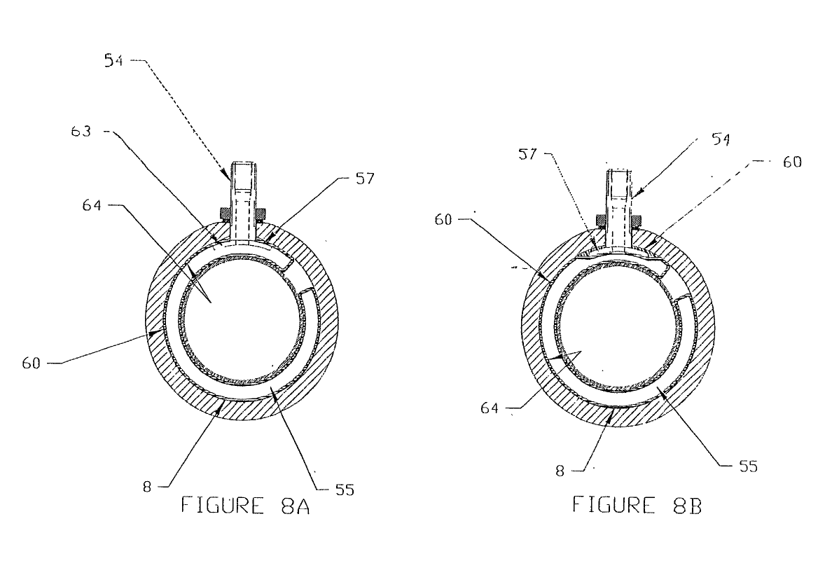

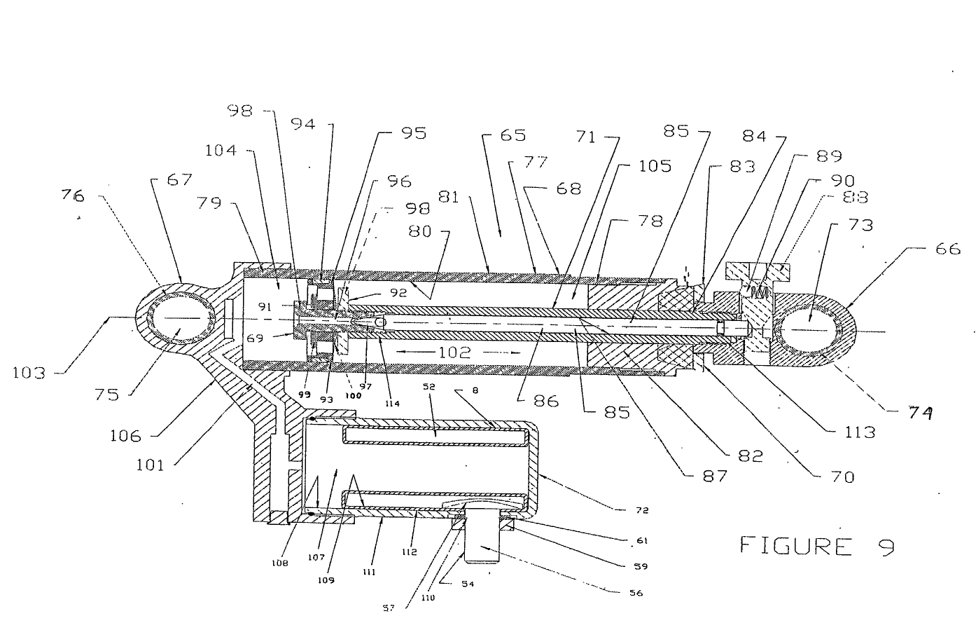

As illustrated in FIG. 8a and FIG. 8b, by attaching the valve 54 to the interior surface 64 of the bladder 8 of FIG. 8a, the thickness of the flange seal reinforcement 63 is reduced as compared to bladder 8 of FIG. 8b, where the valve 54 is attached to the exterior surface 60 of the bladder 8. In order to maintain an air-tight seal once the bladder is inserted into the annular cavity and secured to the outer housing, the flange seal reinforcement 63 secured to bladder 8 of FIG. 8a is thinner than the flange seal reinforcement 63 that is secured to bladder 8 of FIG. 8b. Having a bladder 8 that has a thinner flange seal reinforcement 63 is desirable, because once the bladder 8 has been inserted into the annular cavity and secured to the outer housing of the shock absorber, the flange seal reinforcement 63 can impinge upon the amount of volume available within the interior chamber 55 for fluid. For instance, the bladder 8 of FIG. 8b with the valve 54 attached to the exterior surface 60, once inserted into the annular cavity 52 and secured to the outer housing of the shock absorber 1, has less internal volume available for the storage of fluid in the interior chamber 55 than the bladder 8 of FIG. 8a where the flange seal reinforcement 63 is thicker. The result is that the bladder 8 of FIG. 8b has less fluid to compress and thus, due to a reduced volume capacity, the bladder 8 of FIG. 8b can be fully compressed before the bladder 8 of FIG. 8a.

FIG. 9 illustrates an alternative embodiment of a damping device in accordance with the present invention. The damping device illustrated in FIG. 9 is a monotube shock absorber 65 and comprises mounts 66 and 67, a housing assembly 68, a piston assembly 69 and end cap assembly 70, a piston rod 71, a reservoir housing 72 and a bladder 8, located within the reservoir housing 72. The piston assembly 69 is mounted within the housing assembly 68 for movement along the longitudinal axis 103. FIG. 9 illustrates the shock absorber 65 in the retracted position.

As illustrated in FIG. 9, the mounts, rod end mount 66 and body end mount 67, are located on opposite ends of the shock absorber 65. The rod end mount 66 is comprised of an opening 73, within which is mounted a bushing 74 comprised of a durable, compressible material. The body end mount 67 is also comprised of an opening 75, within which is mounted a bushing 76 comprised of a durable, compressible material.

The housing assembly 68 comprises an outer housing 77. In an embodiment, the outer housing 77 is cylindrical in form, and is defined by two opposite ends 78 and 79, and an interior surface 80 and an exterior surface 81. In the alternative, the outer housing 77 is elliptical or oval in shape. The outer housing 77 can be joined at one end by the body end mount 67 and at the opposite end by the end cap assembly 70.

The end cap assembly 70 comprises seal head 82 and bumper 83. Seal head 82 defines the farthest point on end 78 that the piston assembly 69 can extend. The shock absorber 65 comprises a piston rod 71 that is in the form of an elongated shaft. The piston rod 71 has two opposite ends 113 and 114, wherein one end 113 is secured within the rod end mount 66 and the other end 114 is secured to the piston assembly 69. The piston rod 71 extends through the bore 84 within the end cap assembly 70 into the housing assembly 68. The piston rod 71 is of such size and shape to be closely, yet slidably received, by the bore 84 within the end cap assembly 70. The receipt of the piston rod 71 by the bore 84 within the end cap assembly 70 permits the piston rod 71 to be slidably moved relative to the housing assembly 68 between an extended position, where the piston rod 71 extends out of the housing assembly 68 and a retracted position, where a majority of the piston rod 71 is located within the housing assembly 68. In one embodiment, the piston rod 71 has a channel 85 to receive an adjustment rod 86. The diameter of the channel 85 is of such size to allow the close receipt of the adjustment rod 86 and to allow the sliding movement of the adjustment rod 86 relative to and lengthwise along the interior wall 87 of the channel 85. The adjustment rod 86 is moved by an adjustment knob 88 that is in contact with the adjustment rod 86, such that movement of the adjustment knob 88 results in movement of the adjustment rod 86 through the channel 85 within the piston rod 71. In an embodiment, the adjustment knob operates by moving a check ball 89 and check spring 90.

The piston assembly 69 has an inner face 91 and an outer face 92. In an embodiment, the piston assembly 69 is cylindrical in shape. In an alternative embodiment, the piston assembly 69 is elliptical or oval in shape. The piston assembly 69 has an outer surface 93, whose diameter is of such size to be closely received by yet permit sliding movement of the piston assembly 69 relative to and lengthwise along the interior wall 80 of the outer housing 77. The piston assembly 69 comprises a piston ring 94 and a piston 95 that is attached to the piston rod 71. The piston 95 has at least one opening 96 that extends through the piston 95 from the inner face 91 of the piston assembly 69 to the outer face 92 of the piston assembly 69. Depending upon the embodiment, the size of the opening 96 can be varied depending on the location of the rebound pin 97. The rebound pin 97 is a tapered pin that can be located at a fixed location within the opening 96, so that the opening 96 is of a fixed, determinable size. In an alternative embodiment, the rebound pin 97 is not located at a fixed position. Instead, the location of the rebound pin 97 can be adjusted by moving the rebound pin 97 into, or out of, the opening 96. The rebound pin 97 is moved into, or out of, the opening 96 by the adjustment rod 86. By moving the rebound pin 97, the size of the opening 96 can be increased or decreased. The piston can also contain additional openings of a fixed size that surround the opening 96.

The piston assembly 69 is further comprised of the stop plate 98, that acts as a barrier between the piston 95 and the seal head 82. The piston ring 94 is bound to the piston 95 and is in contact with the interior surface 80 of the outer housing 77. The piston ring 94 can form a barrier that prevents hydraulic fluid from flowing between the piston 95 and the interior surface 80 of the outer housing 77. The piston 95 is comprised of an opening 96 that extends from the inner face 91 of the piston assembly 69 to the outer face 92 of the piston assembly 69. Other openings extending from the inner face 91 of the piston assembly 69 to the outer face 92 of the piston assembly 69 can be located in the piston 95. The axial location of the piston 95 within the piston assembly is maintained by the piston retaining bolt 98. The piston assembly can also be comprised of the valve shims 99 and 100. The valve shims 99 and 100 are round washers made of spring steel that cover the openings of the openings surrounding the opening 96 within the piston 95. The valve shims 99 and 100 act as dampers that regulate the amount of hydraulic fluid that flows through the openings. Once the pressure of the hydraulic fluid applies sufficient force on the valve shims 99 and 100, the valve shims 99 and 100 begin to flex, and hydraulic fluid begins to flow through the openings. The greater the pressure exerted by the hydraulic fluid on the valve shims 99 and 100, the greater the amount of hydraulic fluid that can flow through the openings. The ability of the valve shims 99 and 100 to flex can be regulated by increasing or decreasing the stiffness of the spring steel from which the valve shims 99 and 100 are constructed. The stiffer the spring steel, the greater the pressure of hydraulic fluid required to flex the valve shims 99 and 100. A shock absorber with stiff valve shims 99 and 100 would generally be associated with shock absorbers that are used in high performance vehicles.

The interior surface 80 of the outer housing 77, in conjunction with the end cap assembly 70 at end 78 and the opening to interior passage 101 at end 79, respectively, collectively define an elongated cavity 102 having a longitudinal axis indicated as 103. The piston assembly 69 divides the elongated cavity 102 into first and second variable volume cavities 104 and 105. The first variable volume cavity 104 is defined by the interior surface 80 of the outer housing 77, end 79 and the inner face 77 of the piston assembly 69, while the second variable volume cavity 105 is defined by the interior surface 80 of the outer housing 77, end 78 and the outer face 92 of the piston assembly 69. As the piston assembly moves along the length of, and relative to, the longitudinal axis 103 of the elongated cavity 102, in one axial direction or the other, between ends 78 and 79, the internal volume of the first chamber 104 increases or decreases while the internal volume of the second chamber 105 decreases or increases respectively.

FIG. 9 further illustrates a reservoir 72 that can be attached to the outer housing 77 by connection 106, which comprises an interior passage 101 for the flow of hydraulic fluid between the elongated cavity 102 and the reservoir cavity 107. Within the reservoir cavity 107 is the bladder 8. To prepare the shock absorber 65 for use, the elongated cavity 102 and the reservoir cavity 107 are filled with a hydraulic fluid. In one embodiment, the hydraulic fluid that is used to fill the elongated cavity 102 and reservoir cavity 107 of the shock absorber 65 is oil. In addition, prior to the use of the shock absorber 65, the bladder 8 is pressurized with a fluid through the valve 54 to a predetermined internal pressure. In one embodiment, the fluid that is used to pressurize the bladder 8 is gas, for instance, air or nitrogen. The force required to compress the shock absorber 65 illustrated in FIG. 9 can be increased or decreased by adjusting the internal fluid pressure within the bladder 8. The internal fluid pressure can be adjusted by introducing fluid into the interior chamber 52 through the valve 54, or by removing the fluid from the interior chamber 52. By increasing the internal fluid pressure within the bladder 8, the bladder 8 can be more difficult to compress. By maintaining either a low internal fluid pressure or no internal fluid pressure within the bladder 8, the bladder can be easier to compress.

As illustrated in FIG. 9, the bladder 8 is of such shape that when the shock absorber is assembled, the bladder 8 encircles and effectively covers a major portion of the interior surface 108 of the reservoir housing 72, forming a fluid flow path within the central portion of the reservoir cavity 107 not occupied by the bladder 8. The bladder 8 is secured to the valve 54 that is comprised of a valve stem 56 and a flange 57. The valve 54 is secured to the interior surface 109 of the bladder 8 by the flange 57. The bladder 8 is secured to the reservoir housing 72 by the valve 54 which is received by the opening 110 in the reservoir housing 72 and operatively secured to the reservoir housing 72 by a nut 59. Once the bladder 8 is secured to the reservoir housing 72, a fluid tight seal is formed that prevents hydraulic fluid from inside the reservoir cavity 107, or fluid stored inside the bladder 8, from escaping or leaking through the opening 110 to the outer surface 111 of the reservoir housing 72.

As further illustrated in FIG. 9, in an embodiment, the axial location of the bladder 8 can be fixed into place within the shock absorber by the flange 57, when the valve 54 is fixably attached to the reservoir housing 72 by the nut 59, securing the bladder 8 to the interior surface 108 of the reservoir housing 72. As illustrated in FIG. 9, the flange 57 can be curved, so that the shape of the flange 57 coincides with the shape of the interior surface 108 of the reservoir housing 72. Depending upon the embodiment, by having the flange 57 coincide in shape with the interior surface 108 of the reservoir housing 72, the flange 57 can be prevented from rotating, or moving in any direction, once the bladder 8 has been secured to the interior surface 108 of the reservoir housing 72. Since the flange 57 is not able to rotate or move, the bladder 8, which is secured to the flange 57, is also prevented from moving within the reservoir cavity 107. Therefore, the bladder 8 cannot be subjected to motions that could lead to abrasions on the exterior surface 112 of the bladder 8, which could result in the rupturing of the bladder 8. Rupturing of the bladder 8 would result in the release of the fluid stored in the bladder 8 into the reservoir cavity 107 and the failure of the shock absorber 65 to function properly. The inability of the bladder 8 to move within the reservoir cavity 107 also ensures that the integrity of the hydraulic fluid flow path within the reservoir cavity 107 is maintained, since the bladder 8 cannot alter its axial configuration to block off the fluid flow path. Other benefits associated with attaching the valve 54 to the interior surface 109 of the bladder 8, that were discussed above for the shock absorber 1 illustrated in FIG. 1 and FIG. 2, are equally applicable for the shock absorber 65 illustrated in FIG. 9.

In another embodiment, that is not shown, a monotube shock absorber can contain a bladder within the elongated chamber. In this embodiment, a barrier can be maintained between the location of the bladder within the elongated chamber and the piston assembly that slidably moves through the elongated chamber. The barrier can contain openings, or valves, that allow the flow of hydraulic fluid between the locations within the elongated chamber where the bladder resides and where the piston assembly can slidably move.

In an embodiment, the bladder 8 illustrated in FIGS. 1-5, 8, and 9 is assembled by a process as follows. In this process, a first piece and a second piece of uncured rubber are formed such that both pieces of uncured rubber are roughly equivalent in size, with the sides of the first piece being equivalent in size to the sides in the second piece of uncured rubber. Those skilled in the art will recognize that the invention may suitably be practiced using any of a variety of compressible materials from which to construct a bladder of the present invention. An opening is created in a first piece of uncured rubber for receipt of a valve. The valve is received by the opening in the first piece of uncured rubber, such that the valve stem extends through the opening and beyond the exterior surface of the bladder. After the valve has been received by the opening, the flange should be oriented within the bladder, so that when the bladder is installed within a damping device, the axial location of the bladder within the housing of the damping device is aligned to ensure that a fluid flow passage can extend for the length of the bladder. The flange should then be brought into contact with the interior surface of the bladder, so that the flange can be secured to the interior surface of the bladder. The radius of the opening within the first piece of uncured rubber can vary, but should not be greater than the diameter of the valve stem. An additional piece of uncured rubber, the flange seal reinforcement, which should have an opening within it, should be fitted over the valve stem and brought into contact with the exterior surface of the bladder. In an embodiment, the flange seal reinforcement should be shaped like a washer and should be the same diameter as the flange. In the next step, the two pieces of uncured rubber, the flange and the flange seal reinforcement should all be treated with a heat vulcanizing cement. Then, the two pieces of uncured rubber, the valve and the flange seal reinforcement should be assembled so that the area that is to form the seal between the first and the second pieces of uncured rubber, the flange and the flange seal reinforcement are all aligned in the positions depicted in FIG. 4 and FIG. 5, both of which show a fully assembled bladder.

In an embodiment, a fine powder is injected into the bladder, so that the first and the second pieces of uncured rubber will not stick together, except in the locations where the cement has been applied. The first and the second pieces of uncured rubber, the flange and the flange seal reinforcement are allowed to bond for a period of 24 hours. In an embodiment, the assembled bladder is placed on a soapstone base and heat cured in an autoclave to vulcanize the joints where cement had been placed and cure the rubber. One advantage of using a soapstone base is that the soapstone base prevents the flange from deforming the opposite side of the bladder during the curing cycle. Other methods can also be used to assemble the bladder of the present invention. Included among these methods are compression molding, rotary molding and injection molding.

The resultant perimeter bonded seam 62 of the bladder 8 is illustrated in FIG. 4 and FIG. 5. The resultant perimeter seam 62 can vary in size, but in one embodiment, the perimeter bonded seam 62 is 0.25 inches in depth. The depth of the flange seal reinforcement 63 illustrated in FIG. 4 and FIG. 5 can vary in size, but in one embodiment, it is 0.9 inches in diameter and 1/32inches thick. In one embodiment, the diameter of the flange seal reinforcement 63 is roughly equal to the diameter of the flange 57. The bladder in FIG. 4 and FIG. 5 can vary in size, but in a one embodiment, parallel sides of the bladder 8 are each 4.50 inches in length, and no less than 4.38 inches in length. Parallel sides of the bladder 8 can vary in length, with the potential different lengths of parallel sides accounting for the variance in the volume of the interior chamber of the rubber bladder. In embodiments, parallel sides are either: 3.5 inches in length, yielding an interior chamber volume of 25 milliliters; 5 inches in length, yielding an interior chamber of 35 milliliters; or 6 inches in length, yielding an interior chamber of 45 milliliters. In one embodiment, when the bladder 8 is inflated, the interior chamber 55 has a depth of approximately 0.14 inches.

The method of assembly described above is preferred over the assembly of a bladder from a single piece of uncured rubber, since no folding of the uncured rubber is required to assemble the bladder. When a bladder is assembled from a single piece of uncured rubber, the uncured rubber is generally folded at the seams where the uncured rubber must be joined to form a seal. The folds impinge on the volume that is available within the bladder once the bladder is inserted within, and secured to, the housing of a damping device.

As illustrated in FIG. 4 and FIG. 5, the thickness of the flange seal reinforcement 63 of the bladder 8 can be minimized, even though the bladder 8 can be pressurized in excess of 100 p.s.i., or in excess of 150 p.s.i., since the bladder 8 does not need to retain this pressure on its own. When the bladder 8 is properly installed in a twin tube shock absorber, and pressurized in excess of 100 p.s.i., or in excess of 150 p.s.i., the bladder 8 will be fully supported on its exterior surface by the hydraulic fluid located within the annular cavity 52. Moreover, because the only gas or air space in the annular cavity 52 is contained inside of the bladder 8, when the bladder 8 is pressurized, the pressure of the hydraulic fluid outside of the bladder 8 will become equal to the pressure of the gas located within the interior chamber 55 of the bladder 8. The result of this equalization of pressure is that the bladder 8 is fully supported by the hydraulic fluid and not subjected to failure, for instance, rupturing due to differences in pressure inside and outside of the bladder 8.

To form the valve 54 as illustrated in FIG. 6 and FIG. 7, a single piece of unformed steel, brass, aluminum, or composite material can be machined by using a lathe or screw machine or similar device to create the valve stem 56 and the flange 57 illustrated in FIG. 6 and FIG. 7. After machining, the valve 54 is plated with a material that is corrosion resistant. In an embodiment, the plating material also enhances the appearance of the valve 54. In an embodiment, the material used for plating is zinc. After the valve 54 has been plated, the plating is removed from the flange 57 to facilitate the bonding of the flange 57 to the interior surface of the bladder 8. Once the plating has been removed from the flange 57, the flange 57 is bent using a forming die to shape the flange 57. In an embodiment, the flange 57 is shaped so that the flange 57 is contoured to match the conformation of the inner surface of the housing of the damping device the flange 57 will abut when the bladder 8 is inserted into and fixably attached to the damping device. By having the flange 57 conform to the inner surface of the housing of a damping device, a leak proof seal can be created that prevents gas from exiting the bladder 8, or hydraulic fluid from leaking out of the damping device. In addition, by conforming the flange 57 to the inner surface of the housing of a damping device, the axial location of the bladder 8 can be fixed, preventing the incidence of abrasions, and subsequent failure due to rupture, that can be imparted if the bladder 8 was sufficiently able to move within the housing of the damping device.

In an embodiment, the present invention provides a bladder that is designed to maximize the internal volume available for fluid by attaching a flange located at the base of a valve on the interior surface of the bladder. In another embodiment, the present invention provides a flange that is contoured to conform to the shape of the inner surface of the damping device, preventing movement of the bladder once it has been fixably attached to the damping device. The bladder of the present invention is also simpler to manufacture and less cumbersome to install in the shock absorber than bladders that locate the valve on the exterior surface of the bladder. The bladder of the present invention stores a compressible fluid under high pressure and can be used in either a twin tube or monotube shock absorber. The present invention bladder can provide high performance damping characteristics in either a twin tube shock absorber or a monotube shock absorber.

All patents and publications mentioned in the specification are indicative of the levels of skill of those skilled in the art to which the invention pertains. All references cited in this disclosure are incorporated by reference to the same extent as if each reference had been incorporated by reference in its entirety individually.

One skilled in the art would readily appreciate that the present invention is well adapted for use in damping devices of which shock absorbers are but one embodiment. The specific methods and damping devices described herein as presently representative of embodiments are exemplary and are not intended as limitations on the scope of the invention. Changes therein, and other uses, will occur to those skilled in the art, and these changes and other uses are encompassed within the spirit of the invention as defined by the scope of the claims. It will be readily apparent to one skilled in the art that varying substitutions and modifications may be made to the invention disclosed herein without departing from the scope and spirit of the invention.

What is claimed is:

1. A damping device, comprising:
a bladder having an exterior surface and an interior surface, wherein the interior surface defines a chamber for storing a compressible fluid; and
a valve attached to the interior surface of the bladder.

2. The damping device of claim 1, wherein the bladder comprises one or more of the following materials: urethane, neoprene, Viton, Nitrile, buna rubber, or silicon.

3. The damping device of claim 1, wherein the bladder is constructed to minimize the distance between the interior surface and the exterior surface.

4. The damping device of claim 1, wherein the valve comprises one or more of the following materials: steel, brass, aluminum, or composite.

5. The damping device of claim 1, wherein the valve further comprises a stem having threads for attaching a nut.

6. The damping device of claim 1, wherein the valve further comprises a flange for attaching the valve to the interior surface of the bladder.

7. The valve of claim 6, wherein the flange is contoured to maintain the axial location of the bladder within the damping device.

8. The valve of claim 6, wherein the flange is connected to the interior surface of the bladder.

9. The damping device of claim 1, wherein a compressible fluid is introduced into the bladder through the valve.

10. The damping device of claim 1, wherein the valve permits the adjustment of the internal pressure of a fluid contained within the bladder.

11. The damping device of claim 1, wherein the fluid volume within the bladder in an expanded condition compared to the total displaceable volume of the piston rod comprises a ratio of about 3:1.

12. The damping device of claim 1, wherein the pressure within the bladder is at least about 100 p.s.i.

13. The damping device of claim 1, wherein the pressure within the bladder is at least about 150 p.s.i.

14. A damping device, comprising:
a first housing defining a first cavity for containing hydraulic fluid;
a piston assembly, slidably received by the first cavity;
a rod joined to the piston assembly for movement therewith; the rod having a first end portion extending from the housing and a second end portion movable with the piston assembly during compression and rebound;
a second housing defining a second cavity wherein the second cavity comprises a bladder of compressible material, and the bladder comprises an interior surface and an exterior surface;
a valve attached to the interior surface of the bladder wherein the bladder is positioned within the second cavity to form an opening for the flow of hydraulic fluid;
a connection between the first housing and the second housing; and
a passage between the first cavity and the second cavity wherein the hydraulic fluid passes through the passage during compression and rebound.

15. The damping device of claim 14, wherein the damping device is a shock absorber.

16. The damping device of claim 15, wherein the shock absorber is a twin tube shock absorber.

17. The damping device of claim 15, wherein the shock absorber is a monotube shock absorber.

18. The damping device of claim 14, wherein the bladder comprises one or more of the following materials: urethane, neoprene, Viton, Nitrile, buna rubber, or silicon.

19. The damping device of claim 14, wherein the bladder is constructed to minimize the distance between the interior surface and the exterior surface.

20. The damping device of claim 14, wherein the valve comprises one or more of the following materials: steel, brass, aluminum, or composite.

21. The damping device of claim 14, wherein the valve further comprises a stem having threads for attaching a nut.

22. The damping device of claim 14, wherein the valve is fixably attached to the second housing by a nut.

23. The damping device of claim 14, wherein the valve contains a flange attaching the valve to the interior surface of the bladder.

24. The damping device of claim 23, wherein the flange is contoured to maintain the axial location of the bladder within the damping device.

25. The damping device of claim 23, wherein the flange is constructed of a material that is attachable to the interior surface of the bladder.

26. The damping device of claim 14, wherein compressible fluid is introduced into the bladder through the valve.

27. The damping device of claim 14, wherein the fluid volume within the bladder in an expanded condition as compared to the total displaceable volume of the piston rod, is in a ratio of about 3:1.

28. The damping device of claim 14, wherein the pressure within the bladder is at least about 100 p.s.i.

29. The damping device of claim 14, wherein the pressure within the bladder is at least about 150 p.s.i.

30. A vehicle, comprising:
a chassis; and
a damping device coupled to the chassis, the damping device, comprising:
a first housing defining a first cavity containing hydraulic fluid;
a piston assembly, slidably received by the first cavity;
a rod joined to the piston assembly for movement therewith;
the rod having a first end extending from the housing and a second end movable with the piston assembly during compression and rebound;
a second housing defining a second cavity; the second cavity containing a bladder of compressible material;
the bladder comprising an interior surface and an exterior surface;
a valve attached to the interior surface of the bladder;
the bladder positioned within the second cavity to leave an opening for the flow of hydraulic fluid;
a connection between the first and the second housing;
a passage between the first and second cavity; and
the hydraulic fluid passing through the passage during compression and rebound.

31. The vehicle of claim 30, wherein the vehicle is one of an airplane, an automobile, a truck, a bicycle, a scale model, an ATV and a motorcycle.

32. The vehicle of claim 30, wherein the damping device is a shock absorber.

33. The vehicle of claim 30, wherein the shock absorber is a twin tube shock absorber.

34. The vehicle of claim 30, wherein the shock absorber is a monotube shock absorber.

35. The vehicle of claim 30, wherein the bladder comprises one or more of the following materials: urethane, neoprene, Viton, Nitrile, buna rubber, or silicon.

36. The vehicle of claim 30, wherein the bladder is constructed to minimize the distance between the interior surface and the exterior surface.

37. The vehicle of claim 30, wherein the valve comprises one or more of the following materials: steel, brass, aluminum, or composite.

38. The vehicle of claim 30, wherein the valve includes a stem having threads for attaching a nut.

39. The vehicle of claim 30, wherein the valve is fixably attached to the second housing by a nut.

40. The vehicle of claim 30, wherein the valve includes a flange attaching the valve to the interior surface of the bladder.

41. The vehicle of claim 40, wherein the flange is contoured to maintain the axial location of the bladder within the damping device.

42. The vehicle of claim 40, wherein the flange comprises a material that is attachable to the interior surface of the bladder.

43. The vehicle of claim 30, wherein compressible fluid is introduced into the bladder by the valve.

44. The vehicle of claim 30, wherein the fluid volume within the bladder in an expanded condition compared to the total displaceable volume of the piston rod comprises a ratio of about 3:1.

45. The vehicle of claim 30, wherein the pressure within the bladder is at least about 100 p.s.i.

46. The vehicle of claim 30, wherein the pressure within the bladder is at least about 150 p.s.i.

47. A damping device, comprising:
a bladder having an exterior surface and an interior surface;
the interior surface defining a chamber which stores a compressible fluid;
a valve containing a stem and a flange;
the flange attaching the valve to the interior surface of the bladder; and
the flange shaped to maintain the axial location of the bladder within the damping device.

48. A valve capable of maintaining the axial location of a compressible bladder within a damping device, comprising:
a valve that contains a flange, the flange attaching the valve to the compressible bladder, the flange contoured to conform to the shape of the damping device.
